(19) United States
(12) Patent Application Publication
(10) Pub. No.: US 2008/0296113 A1
(43) Pub. Date: Dec. 4, 2008

(54) CONTROLLING METHOD AND CONTROLLING APPARATUS FOR STARTING CLUTCH

(75) Inventors: Toshihiro Naruse, Fukuroi-shi (JP); Masaki Sakai, Fukuroi-shi (JP); Tomoyuki Miyazaki, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K.K.

(21) Appl. No.: 12/128,639

(22) Filed: May 29, 2008

(30) Foreign Application Priority Data
Jun. 4, 2007 (JP) 2007-148080

(51) Int. Cl. F16D 25/00

(52) U.S. Cl. 192/3.63

(57) ABSTRACT

The present invention provides a controlling method for a starting clutch disposed between a transmission and an engine of a vehicle and having a wet type multi-plate clutch for transmitting a power and a piston for pressing the wet type multi-plate clutch to engage the wet type multi-plate clutch, wherein, while the starting clutch is being subjected to creep control, the pressing force of the piston is controlled variably.

### BACKGROUND OF THE INVENTION

1. Field of the Invention

The present invention relates to a controlling method and a controlling apparatus for a starting clutch used as a starting device of an automobile and the like.

2. Related Background Art

Conventionally, in automatic transmissions i.e. ATs, the starting of a vehicle was performed by transmitting torque through a torque converter. The torque converter was mounted to many AT vehicles since the torque converter has a torque amplifying effect and provides smooth torque transmission.

On the other hand, the torque converter has a disadvantage that a large amount of slip is generated during the torque transmission and, thus, the torque converter has less efficiency.

Therefore, in recent years, there has been proposed a technique in which a starting clutch is used in place of the torque converter, and the torque has been amplified at a low speed range by reducing a gear ratio and by increasing the number of speed change stages.

In general, the starting clutch includes a wet type multi-plate clutch housed in a clutch case. In the multi-plate clutch, friction plates as friction engaging elements at an output side and separator plates as friction engaging elements at an input side are arranged alternately along an axial direction. With this arrangement, a power is transmitted by engaging the friction plates with the separator plates by means of a piston.

Although the starting clutch has excellent performance, since there is clearance between the friction engaging elements in a clutch released or disengaged condition, upon starting the vehicle, when an acceleration pedal is depressed, a time difference is generated between the depression of the acceleration pedal and the engagement of the starting clutch until the starting clutch is engaged, thereby arising problems that waste throttling is generated and that shock is apt to be generated upon the engagement of the clutch.

To solve the above problem, there has been proposed a technique in which the vehicle begins to start smoothly by smooth engagement of the clutch upon starting the vehicle by using a control method such as creep control. For example, Japanese Patent Application Laid-open No. 2000-320572 discloses a technique in which creep torque is generated by always pressing friction engaging elements of a starting clutch.

In a case where a conventional vehicle having an automatic transmission is put into a narrow garage backwardly, when a shift lever is switched to reverse (R) and the vehicle is run at a very low speed while adjusting a creep force by controlling the depression of a brake pedal, even a beginner can park the vehicle easily. However, if there is a slope and/or a step in the route to the parking area, the vehicle cannot be moved by the conventional creep force and, thus, it is required to move the vehicle backwardly by depressing the acceleration pedal. As a result, it is difficult to adjust the depression of the acceleration pedal and the timing of the braking.

### SUMMARY OF THE INVENTION

Accordingly, an object of the present invention is to provide a controlling method and a controlling apparatus for a starting clutch in which torque transmitted to a vehicle is increased by increasing a pressing force of the starting clutch by variably controlling a pressing force of a piston while performing creep control of the starting clutch so that, if there is a slope and/or a step, the vehicle can be parked only by manipulating a brake and the vehicle can be controlled to satisfy the driver's request.

To achieve the above object, the present invention provides a controlling method for a starting clutch disposed between a transmission and an engine of a vehicle and having a wet type multi-plate clutch for transmitting power and a piston for pressing the wet type multi-plate clutch to engage the wet type multi-plate clutch, wherein, while the starting clutch is being subjected to creep control, the pressing force of the piston is controlled variably.

Further, to achieve the above object, the present invention provides a controlling apparatus for a starting clutch disposed between a transmission and an engine of a vehicle and having a wet type multi-plate clutch for transmitting power and a piston for pressing the wet type multi-plate clutch to engage the wet type multi-plate clutch, the apparatus comprising means for variably controlling the pressing force of the piston while the starting clutch is being subjected to creep control.

According to the starting clutch of the present invention, the following effects can be achieved.

By variably controlling the pressing force of the piston of the starting clutch, since the torque which is wished by the driver can be transmitted to wheels of the vehicle, a low speed running operation such as a parking operation of the vehicle on the slope can be facilitated. As a result, the parking operation on the road having the slope and/or step is facilitated in comparison with the conventional parking operations.

In case of a creep mode, the pressing force of the starting clutch can be controlled on the basis of the driver's intention by a switching operation.

In the specification, the term “creep control” means the fact that, in a drive (forward) mode or a reverse mode of a select lever of the transmission, under a condition that a brake is set to an OFF condition and an opening degree of a throttle is 0%, when the vehicle is running at a speed smaller than a predetermined value, the creep of the starting clutch is controlled.

Further features of the present invention will become apparent from the following description of exemplary embodiments with reference to the attached drawings.

### BRIEF DESCRIPTION OF THE DRAWINGS

FIG. 1 is an axial sectional view of a starting clutch, for explaining an embodiment of controlling method and apparatus for the starting clutch according to the present invention;

FIG. 2 is a graph showing a relationship between a pressing force applied to a piston and a value of a switch, showing a condition that the pressing force is changed in a non-stepped fashion with respect to the value of the switch;

FIG. 3 is a graph showing a relationship between a pressing force applied to a piston and a value of a switch, showing a condition that the pressing force is changed in a stepped fashion with respect to the value of the switch; and

FIG. 4 is a flow chart showing steps up to creep control of the starting clutch.

### DETAILED DESCRIPTION OF THE INVENTION

Now, an embodiment of the present invention will be fully explained with reference to the accompanying drawings. Incidentally, it should be noted that the embodiment described hereinbelow is merely an example of the present invention and that various alterations can be made.

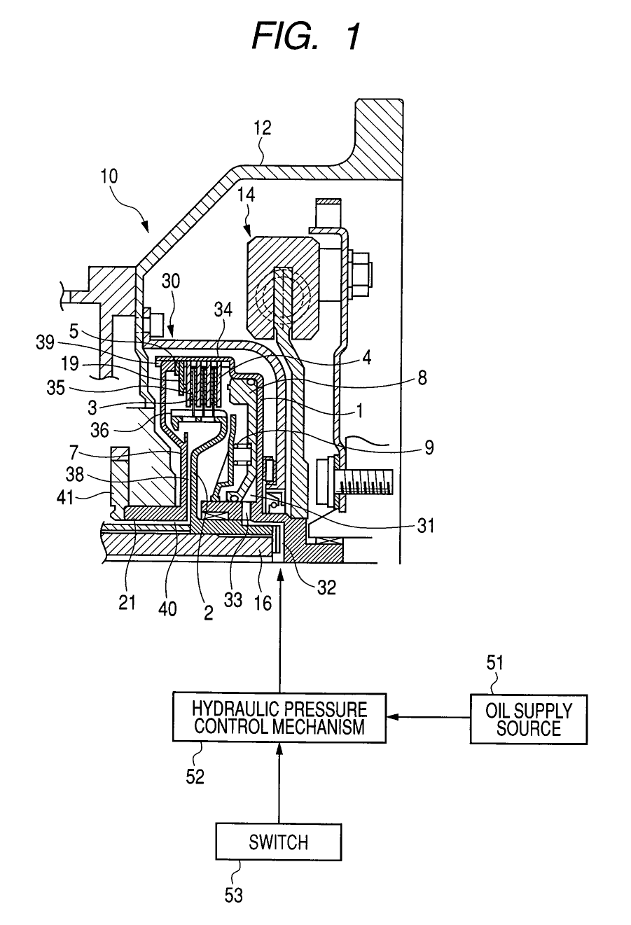

FIG. 1 is an axial sectional view of a starting clutch, for explaining an embodiment of controlling method and apparatus for the starting clutch according to the present invention. A starting clutch 10 includes a clutch drum or clutch case 1 and a wet type multi-plate clutch 30 housed in the clutch case. Within the clutch case 1, substantially annular friction plates 3 as friction engaging elements at an output side of the wet type multi-plate clutch 30 and substantially annular separator plates 4 as friction engaging elements at an input side are arranged alternately along an axial direction. At an axial one end (open end) of the clutch case 1, a substantially annular backing plate 19 is fixedly supported by a substantially annular stop ring 5 in the axial direction, thereby holding the separator plate 4.

The annular clutch case 1 is provided at its outer periphery with a drum portion 34. The drum portion 34 is provided at its inner periphery with a spline portion 39 with which the separator plates 4 are engaged for an axial sliding movement.

In the illustrated embodiment, although the wet type multi-plate clutch 30 is constituted by three friction plates 3 and three separator plates 4, it should be noted that the number of the input and output side friction engaging elements can be changed voluntarily in accordance with required torque. Further, substantially annular friction materials 35 or plural friction material segments 35 are secured to axial both surfaces of the friction plate 3 by an adhesive or the like. Further, the friction materials 35 may be secured to the separator plates 4 or the friction materials 35 may be secured to one of surfaces of the friction plate 3 and the separator plate 4 alternately.

In FIG. 1, a piston 8 is provided within a closed end portion of the clutch case 1. The piston 8 is mounted within the clutch case 1 for an axial movement so that the piston can abut against the separator plate 4 to apply a pressing force to the separator plate.

A hydraulic chamber 31 is defined between the piston 8 and an inner surface of the clutch case 1, which hydraulic chamber is maintained in an oil-tight condition by two O-rings. By supplying hydraulic oil from an oil path (described later) to the hydraulic chamber 31, the shifting movement of the piston 8 is controlled, thereby obtaining a predetermined pressing force and applying the predetermined pressing force to the piston 8. A spring 9 for always biasing the piston 8 toward the hydraulic chamber 31 in a clutch released condition is provided at a side of the piston opposite to the hydraulic chamber 31.

When the predetermined hydraulic pressure is supplied to the hydraulic chamber 31, the piston 8 is shifted to the left in FIG. 1, thereby tightening the wet type multi-plate clutch 30 between the piston and the backing plate 19.

The friction plate 3 of the wet type multi-plate clutch 30 is provided with grooves (not shown) each of which is formed to have a depth substantially the same as a thickness of the friction material 35 and a circumferential width greater than 3 mm. With this arrangement, a cooling effect is enhanced even in the engagement condition of the starting clutch 10 which is hard to be cooled. Further, according to the present invention, since the lubricant oil is always supplied with the flow amount smaller than that during the idle rotation so as to cool the clutch even during the engagement thereof, the cooling efficiency is further enhanced.

A hub member 2 fitted on an input shaft 16 to be rotated integrally with the input shaft 16 of the transmission is provided at its outer periphery with a spline portion 36. The friction plates 3 are fitted into the spline portion 36 for an axial sliding movement. Accordingly, a power inputted from a crank shaft (not shown) is transmitted to the transmission (not shown) through a damper device 14 (described later), clutch case 1, wet type multi-plate clutch 30, hub member 2 and input shaft 16.

The clutch case 1 of the wet type multi-plate clutch 30 is provided with the above-mentioned damper device 14 as a shock absorbing mechanism for absorbing shock generated upon the engagement of the clutch. The damper device 14 includes a spring and a retainer plate for holding the spring.

An axial one end of the input shaft 16 is provided at its outer periphery with a spline portion into which the hub member 2 is fitted. Accordingly, the input shaft 16 and the hub member 2 are rotated integrally with each other.

A cover member 7 is provided at an open end portion of the clutch case 1. An outer diameter edge portion of the cover member 7 is fitted in a spline portion 39 of the clutch case 1. Thus, the cover member 7 is rotated together with the clutch case 1. A narrow lubricant oil passage 38 is defined between the cover member 7 and the hub member 2. As can be seen from FIG. 1, by providing the cover member 7, the wet type multi-plate clutch 30 is disposed in a substantially closed space.

Here, the lubricant oil for lubricating the wet type multi-plate clutch 30 is supplied to the interior of the clutch through an oil path 40 defined between the cover member 7 and the input shaft 16 and the lubricant oil passage 38, by a lubricant oil supplying source (not shown) and an oil pump 41.

The pressing force applied to the piston 8 is generated by oil pressure supplied to the hydraulic chamber 31. Hydraulic oil supplied from an oil supplying source 51 is adjusted to predetermined oil pressure by an oil pressure controlling mechanism 52 and is flown into the hydraulic chamber 31 through a passage 32 defined between the output shaft and an inner diameter portion of the clutch case 1 and a through hole 33 formed in the inner diameter portion of the clutch case 1, thereby applying the predetermined pressing force to the piston 8.

A switch 53 provided on the vehicle (not shown) can control the pressing force of the piston 8 via the oil pressure controlling mechanism 52 by the driver's manipulation of the switch. As will be described later, by manipulating the switch 53, the variable control of the pressing force can be performed in a non-stepped fashion or a stepped fashion.

Further, by manipulating the switch 53, the pressing force of the piston 8 is changed from zero to a predetermined pressing force in the non-stepped fashion or the stepped fashion. Here, the term “predetermined pressing force” means a pressing force of level in which the engine is not stopped. Since the switch 53 has an OFF mode in which the operation is stopped, if the driver does not want to use the function, the function can be stopped.

The switch 53 can control the pressing force on the basis of the driver's intention by changing a value of the switch, or manually setting the pressing force of the piston 8 and is preferably designed so that the pressing force controlled by the driver can be set to any magnitude. As mentioned above, the switch 53 has the OFF mode in which the control is made OFF and, when the control is made OFF, creep control is performed with a pre-determined pressing force. In this case, the pressing force of the piston 8 may be automatically set in accordance with the measurement result of the angle of inclination of the road.

By providing the switch 53, the pressing force of the piston 8 of the starting clutch 10 can be controlled variably, with the result that torque wanted by the driver can be transmitted to wheels of the vehicle, and, consequently, the very low speed running or driving operation of the vehicle such as a parking operation on the slope can be facilitated. As a result, the parking operation on the road having the slope and/or the step can be facilitated in comparison with the conventional parking operations.

In case of a creep mode, the pressing force of the starting clutch can be controlled in accordance with the driver's intention by a switching operation.

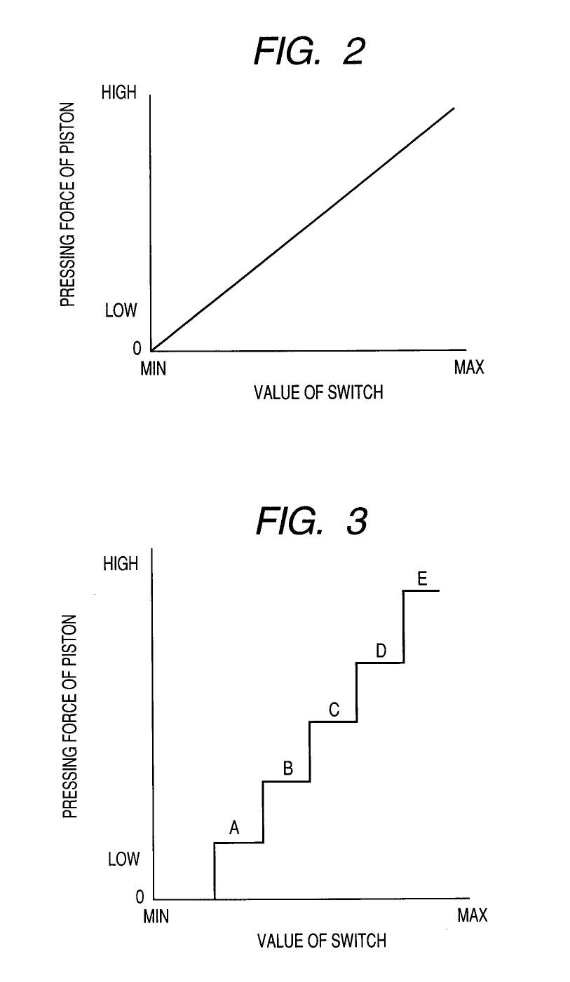

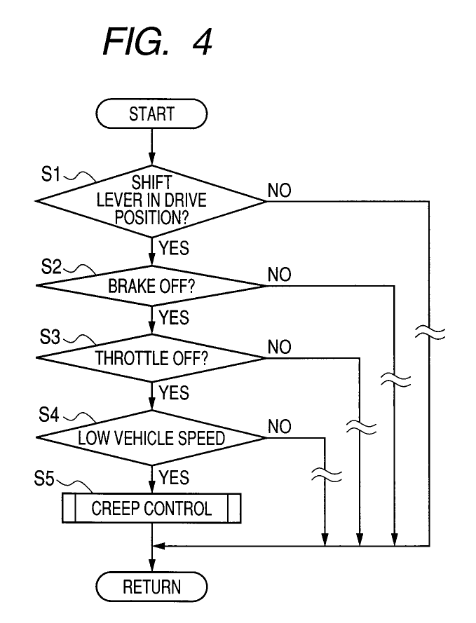

Here, change in the pressing force applied to the piston 8 will be explained with reference to FIGS. 2 and 4. FIG. 2 is a graph showing a relationship between the pressing force applied to the piston 8 and a value of the switch 53, showing a condition that the pressing force is changed in a non-stepped fashion with respect to the value of the switch 53. By the voluntary operation of the driver, while the value of the switch 53 is being changed from MIN to MAX, the pressing force applied to the piston 8 starts from 0 (zero) and is changed up to “strong” in a non-stepped fashion. In this case, the “strong” pressing force corresponds to the “predetermined pressing force”.

FIG. 3 is a graph showing a relationship between the pressing force applied to the piston 8 and a value of the switch 53, showing a condition that the pressing force is changed in a stepped fashion with respect to the value of the switch 53. By the voluntary operation of the driver, while the value of the switch 53 is being changed from MIN to MAX, the pressing force applied to the piston 8 starts from 0 (zero) and is changed up to “strong” in a stepped fashion. Similar to the graph of FIG. 2, the “strong pressing force corresponds to the predetermined pressing force”.

In FIG. 3, regardless of the value of the switch 53, the magnitude of each of steps as ranges A, B, C, D and E in which the pressing force becomes constant is constant, here. However, it should be noted that the number of the steps can be increased and the magnitudes of the steps can be differentiated.

FIG. 4 is a flow chart showing steps up to the creep control of the starting clutch according to the embodiment of the present invention. First of all, in a step S1, when it is ascertained that the shift lever of the vehicle is situated in a running range or drive position (forward or reverse), the program goes to a step S2. In the step S2, when it is ascertained that the brake is OFF (the brake pedal is not depressed and the parking brake is OFF), the program goes to a step S3, where it is ascertained whether the acceleration pedal is not depressed and the opening degree of the throttle is zero (i.e. throttle is OFF).

When it is ascertained that the throttle is OFF, the program goes to a step S4, where it is ascertained whether the speed of the vehicle is a low speed smaller than a predetermined speed. When the low speed is ascertained, the program goes to a step S5, where the creep control according to the embodiment of the present invention is performed. If all of the contents of the steps S1 to S2 are not ascertained, the program does not go to the step S5, and the switch 53 cannot be operated. After the step S5 is executed, when the operation is finished by OFF of the switch 53, the program is returned to “Start”.

The ascertaining operations in the steps S1 to S4 serve to ascertain whether the vehicle is in the creep condition or not and are performed automatically by electrical means or the like. ON of the switch 53 in the creep control of the step S5 is performed manually by the driver. However, in the steps S1 to S4, if the ascertaining operations are confirmed, in the step S5, the switch 53 may be automatically switched to ON in place of the driver's manual switching of the switch. In this case, it is preferable that the driver is informed that creep control is being executed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-148080 filed on Jun. 4, 2007, which is hereby incorporated by reference in its entirety.

What is claimed is:

1. A controlling method for a starting clutch disposed between a transmission and an engine of a vehicle and having a wet type multi-plate clutch for transmitting a power and a piston for pressing said wet type multi-plate clutch to engage said wet type multi-plate clutch, wherein:
while said starting clutch is being subjected to creep control, the pressing force of said piston is variably controlled.

2. A controlling method for a starting clutch according to claim 1, wherein the pressing force of said piston is manually set.

3. A controlling method for a starting clutch according to claim 1, wherein the pressing force of said piston is automatically set.

4. A controlling method for a starting clutch according to claim 1, wherein the variable control is performed in a non-stepped or stepped fashion.

5. A controlling method for a starting clutch according to claim 1, wherein the variable control is performed in such a manner that the pressing force of said piston is changed zero to a predetermined pressing force in a non-stepped fashion.

6. A controlling method for a starting clutch according to claim 1, wherein the variable control is performed in such a manner that the pressing force of said piston is changed zero to a predetermined pressing force in a stepped fashion.

7. A controlling method for a starting clutch according to claim 6, wherein the predetermined pressing force is a pressing force of level in which said engine is not stopped.

8. A controlling apparatus for a starting clutch disposed between a transmission and an engine of a vehicle and having a wet type multi-plate clutch for transmitting a power and a piston for pressing said wet type multi-plate clutch to engage said wet type multi-plate clutch and adapted to be mounted to said vehicle, comprising:
a variable control means for variably controlling the pressing force of said piston while said starting clutch is being subjected to creep control.

9. A controlling apparatus for a starting clutch according to claim 8, wherein the pressing force of said piston is manually set.

10. A controlling apparatus for a starting clutch according to claim 8, wherein the pressing force of said piston is automatically set.

11. A controlling apparatus for a starting clutch according to claim 8, wherein said variable control means is a switch provided in said vehicle.

12. A controlling apparatus for a starting clutch according to claim 11, wherein said switch can be manipulated manually by a driver.

13. A controlling apparatus for a starting clutch according to claim 12, wherein the variable control is performed in a non-stepped or stepped fashion by the manipulation of said switch.

14. A controlling apparatus for a starting clutch according to claim 11, wherein, in the variable control, the pressing force of said piston is changed in a non-stepped fashion from zero to a predetermined pressing force by the manipulation of said switch.

15. A controlling apparatus for a starting clutch according to claim 11, wherein, in the variable control, the pressing force of said piston is changed in a stepped fashion from zero to a predetermined pressing force by the manipulation of said switch.

16. A controlling apparatus for a starting clutch according to claim 14, wherein the predetermined pressing force is a pressing force of level in which said engine is not stopped.

17. A controlling apparatus for a starting clutch according to claim 11, wherein said switch has an OFF mode in which the operation is stopped.

18. A controlling apparatus for a starting clutch according to claim 8, further comprising a means for generating the pressing force applied to said piston by oil pressure.

19. A controlling apparatus for a starting clutch according to claim 8, further comprising a means for mechanically generating the pressing force applied to said piston.

20. A controlling apparatus for a starting clutch according to claim 19, wherein said means for generating the pressing force includes a ball screw and a motor.
